(19) United States
(12) Patent Application Publication
(10) Pub. No.: US 2009/0002425 A1
(43) Pub. Date: Jan. 1, 2009

(54) INK JET PRINT HEAD AND METHOD OF DETECTING MISSING NOZZLE

(75) Inventor: Jae Sik Min, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/107,174

(22) Filed: Apr. 22, 2008

(30) Foreign Application Priority Data
Jun. 29, 2007 (KR) 2007-0065437

(51) Int. Cl. B41J 29/38

(52) U.S. Cl. 347/17

(57) ABSTRACT

An apparatus and method of detecting a missing nozzle in an ink jet print head can detect a missing nozzle with a simple process when the missing nozzle is generated. The method of detecting the missing nozzle used in the ink jet print head provided with plural chambers in which an ink is filled, plural heaters to heat the ink in the chambers, and plural nozzles corresponding to the heaters, includes detecting a temperature of each of the heaters, and when the detected temperature deviates from a predetermined temperature range, determining that the nozzle corresponding to the heater is the missing nozzle.

### CROSS-REFERENCE TO RELATED APPLICATIONS

This application claims priority under 35 U.S.C. §119(a) from Korean Patent Application No. 2007-0065437, filed on Jun. 29, 2007 in the Korean Intellectual Property Office, the disclosure of which is incorporated herein by reference in its entirety.

### BACKGROUND OF THE INVENTION

1. Field of the Invention

The present general inventive concept relates to an ink jet print head, an image forming apparatus having the same, and a method of detecting a missing nozzle, and more particularly, to an apparatus and method of detecting a missing nozzle of an ink jet print head by sensing temperatures of respective heaters provided in the ink jet print head.

2. Description of the Related Art

An ink jet print head is a device which forms an image by ejecting ink droplets onto a desired position on a printing medium.

The ink jet print head is largely classified as an electro-thermal type and a piezoelectric type according to the ink droplet ejection mechanism. The electro-thermal type print head generates bubbles in the ink using a heat source and ejects the ink droplets by the expansive power of the bubbles.

The electro-thermal type print head generally includes a substrate which is configured as a silicon wafer, an ink supply hole which is formed on the substrate to supply an ink, a flow channel layer which forms a flow channel and plural chambers on the substrate, a nozzle layer which is disposed on the flow channel layer and has plural nozzles corresponding to the ink chambers, and plural heaters which are provided corresponding to the ink chambers to heat the ink in the ink chambers.

In the ink jet print head, if any part of the plural nozzles is clogged or damaged when any part of the heaters or the actuators corresponding to the respective nozzles works improperly, or a circuit applying electric power to the heaters or the actuators malfunctions, white lines are formed on the printing medium, which results in deterioration of a printing quality.

A nozzle, which is damaged and cannot eject an ink, is called a missing nozzle. A technique for detecting the missing nozzle and compensating for the missing nozzle to prevent the deterioration of a printing quality has been developed.

An example of methods for detecting the missing nozzle is disclosed in Korean Patent Publication No. 10-0636236. The disclosed method is to detect the missing nozzle by scanning a result printed in a printing unit.

In other words, the conventional method includes printing a test pattern by ejecting the ink onto the printing medium through nozzles, and scanning the test pattern using a scan sensor to detect the missing nozzle.

However, the conventional method for detecting the missing nozzle is troublesome and complicated because of performing the processes of printing the test pattern and seeking out the missing nozzle through the scanning, thereby taking much time to detect the missing nozzle.

Further, the conventional detecting technique seeks out the missing nozzle by repeating the printing of the test pattern at a regular interval after practically printing for a predetermined amount. However, if the missing nozzle is generated right after the missing nozzle detecting process, an image of a low quality is obtained until the next missing nozzle detecting process. In other words, the conventional detecting technique cannot detect the missing nozzle immediately when the missing nozzle is generated.

Since it is necessary to eject the ink onto the printing medium to perform the missing nozzle detecting process, the printing medium or the ink is unnecessarily consumed during the missing nozzle detecting process.

Since position information of the missing nozzle is detected using the scan sensor, it is difficult to detect the position of the missing nozzle more accurately.

### SUMMARY OF THE INVENTION

The present general inventive concept provides an apparatus and method of detecting a missing nozzle of an ink jet print head using a simple process when the missing nozzle is generated.

The present general inventive concept also provided an image forming apparatus and method of detecting a missing nozzle of an ink jet print head and detecting an accurate position of the missing nozzle.

Additional aspects and/or advantages of the general inventive concept will be set forth in part in the description which follows and, in part, will be obvious from the description, or may be learned by practice of the general inventive concept.

The foregoing and/or other aspects and utilities of the present general inventive concept may be achieved by providing a method of detecting a missing nozzle in an ink jet print head provided with plural chambers in which an ink is filled, plural heaters to heat the ink in the chambers, and plural nozzles corresponding to the heaters, the method including detecting a temperature of each of the heaters, and when the detected temperature deviates from a predetermined temperature range, determining that the nozzle corresponding to the heater is a missing nozzle.

The detecting of the temperature may include detecting the temperature using a thin film thermocouple which is deposited on an upper portion of each of the heaters.

The thermocouple may be configured as a k-type thermocouple.

The predetermined temperature range may be from 100° C. to 330° C.

The foregoing and/or other aspects and utilities of the present general inventive concept may also be achieved by providing an ink jet print head including plural nozzle modules each having chambers in which an ink is filled, nozzles corresponding to the chambers, and heaters to heat the ink in the chambers, temperature sensing parts which are provided in the respective nozzle modules to detect a heating temperature of the heaters, and a control part which determines whether a missing nozzle is generated. When the temperature detected by the temperature sensing part deviates from a predetermined temperature range, the control part may determine that the nozzle of the corresponding nozzle module is a missing nozzle.

The ink jet print head may further include a passivation layer protecting the heaters. The temperature sensing parts may be provided on the passivation layer, correspondingly to the heaters.

The ink jet print head may further include an anti-cavitation layer provided on the passivation layer. The temperature sensing parts may be provided between the passivation layer and the anti-cavitation layer, correspondingly to the heaters.

The temperature sensing parts may include a thin film thermocouple.

The temperature sensing parts may perform a cavitation-prevention function.

The foregoing and/or other aspects and utilities of the present general inventive concept may also be achieved by providing an ink jet print head including a substrate which is formed with heaters and a passivation layer protecting the heaters, a flow channel layer which defines chambers corresponding to the heaters and a flow channel connected to the chambers, a nozzle layer which is formed with nozzles corresponding to the chambers, first and second metal layers which are bonded onto the passivation layer, correspondingly to the nozzles, to form temperature sensing parts, and a control part which determines whether a missing nozzle is generated. When a temperature detected by the temperature sensing part deviates from a predetermined temperature range, the control part may determine that the nozzle is the missing nozzle.

The foregoing and/or other aspects and utilities of the present general inventive concept may also be achieved by providing an ink jet print head including a plurality of nozzle modules each having a chamber in which an ink is filled, a nozzle corresponding to the chamber, and a heater to heat the ink in the chamber, and a temperature sensing unit provided in the respective nozzle modules to detect a heating temperature of the heater of the respective modules.

The foregoing and/or other aspects and utilities of the present general inventive concept may also be achieved by providing an image forming apparatus including an ink jet print head having a plurality of nozzle modules each having a chamber in which an ink is filled, a nozzle corresponding to the chamber, and a heater to heat the ink in the chamber, and a temperature sensing unit provided in the respective nozzle modules to detect a heating temperature of the heater of the respective modules.

The image forming apparatus may further include a control part connected to the ink jet print head to determines whether the nozzle is a missing nozzle when the heating temperature detected by the temperature sensing unit deviates from a predetermined temperature range.

The temperature sensing unit may include first temperature sensing elements disposed to correspond to positions of heaters of the nozzle modules, and a second temperature sensing element disposed along the heaters to be connected to the positions of the first temperature sensing elements, and the heating temperature may include a plurality of temperatures to correspond to the positions formed between the respective first temperature sensing elements and the second temperature sensing element.

The temperature sensing unit may include a sensor unit connected to the respective first temperature sensing elements and the second temperature sensing element to detect temperatures of the positions corresponding to respective heaters.

The temperature sensing unit may include a first temperature sensing element and a second temperature sensing element to correspond to each position of heaters of the respective nozzle modules, and a sensor unit connected to the first temperature sensing element and the second temperature sensing element to detect a temperature of the corresponding heater as the heating temperature.

The temperature sensing unit may include a first temperature sensing element and a second temperature sensing element formed to corresponding to the heater of the respective nozzle modules to transfer heat, and a sensor unit connected to the first temperature sensing element and the second temperature sensing element to detect a temperature of the corresponding heater according as the heating temperature according to the heat.

The respective heaters may generate heat to be transmitted to the temperature sensing unit, and the temperature sensing unit may detect the heating temperature of the heater among the heaters according to a difference of the heat among the respective heaters.

Different heats may be transmitted from the respective heaters to the temperature sensing unit, and the temperature sensing unit may detect the heating temperature of the heater and a location of the heater among the heaters of the respective nozzle modules according to the different heats.

The temperature sensing unit may be disposed on a path formed from the heater to the ink chamber.

The temperature sensing unit may be disposed between the heater and the ink chamber.

The nozzle modules may include a substrate which is formed with heaters and a passivation layer protecting the heaters, a flow channel layer which defines chambers corresponding to the heaters and a flow channel connected to the chambers, a nozzle layer which is formed with nozzles corresponding to the chambers, and the temperature sensing unit may include first and second metal layers which are bonded onto the passivation layer to correspond to the respective nozzles, to form the temperature sensing unit.

The image forming apparatus may include a control part which determines whether one of the nozzles is a missing nozzle when the temperature detected by the temperature sensing unit deviates from a predetermined temperature range.

The image forming apparatus may include a control part which determines whether one of the nozzles is a missing nozzle when the temperature detected by the temperature sensing unit deviates from a predetermined temperature range, and the ink jet print head and the control part may be formed in a single integrated body.

The plurality of nozzle modules and the temperature sensing unit may be formed in a single monolithic body.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, of which:

FIG. 1 is a plan view schematically illustrating an ink jet print head usable with an image forming apparatus in accordance with an exemplary embodiment of the present general inventive concept;

FIG. 2 is a sectional view taken along line I-I in FIG. 1;

FIG. 3 is a partial sectional perspective view schematically illustrating the ink jet print head of FIG. 1 in accordance with an exemplary embodiment of the present general inventive concept;

FIG. 4 is a sectional view illustrating an ink jet print head in accordance with another exemplary embodiment of the present general inventive concept;

FIG. 5 is a control block diagram illustrating an image forming apparatus having an ink jet print head in accordance with an exemplary embodiment of the present general inventive concept; and

FIG. 6 is a block diagram illustrating a control part and a temperature sensing unit of the image forming apparatus of FIG. 5 according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to like elements throughout. The embodiments are described below to explain the present general inventive concept by referring to the figures.

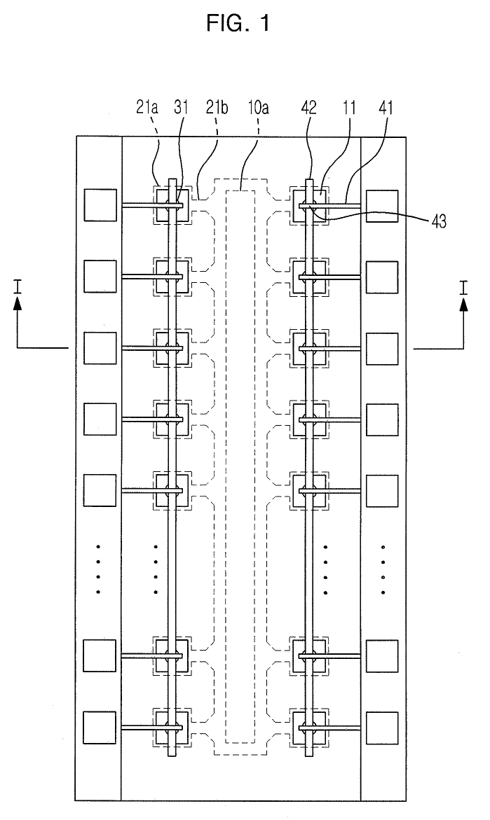

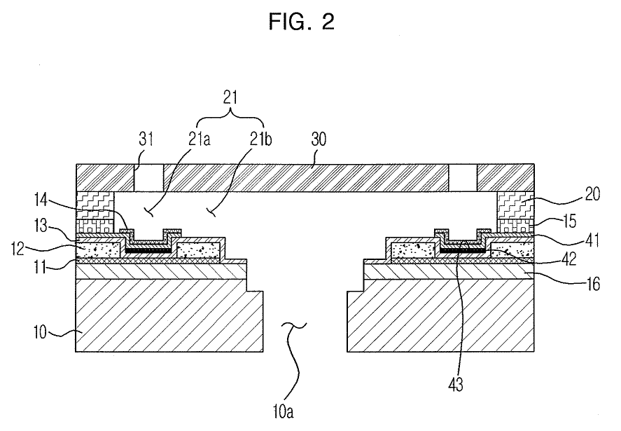

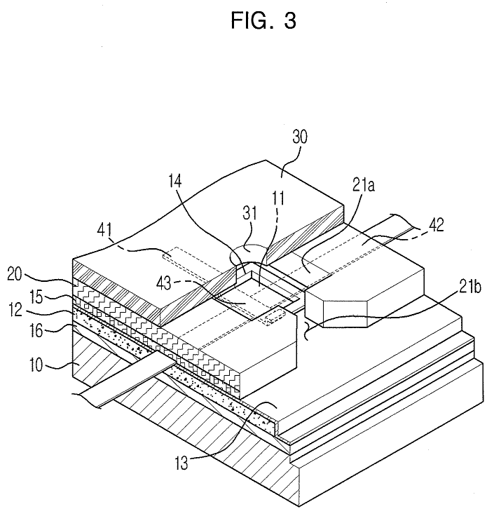

FIG. 1 is a plan view schematically illustrating an ink jet print head usable with an image forming apparatus according to an exemplary embodiment of the present general inventive concept, FIG. 2 is a sectional view taken along line I-I in FIG. 1, and FIG. 3 is a partial sectional perspective view schematically illustrating the ink jet print head according to an exemplary embodiment of the present general inventive concept.

An electro-thermal type ink jet print head can be used as an example of the ink jet print head of the present general inventive concept to generate bubbles in an ink using a heat source and ejects ink droplets by an expansive power of the bubbles.

As illustrated in FIGS. 1, 2, and 3, the ink jet print head of the present embodiment includes a substrate 10, on which heaters 11 are provided as an ejection pressure generating element for ink ejection. Electrodes 12 are formed on the heaters 11, and a passivation layer 13 and an anti-cavitation layer 14 are formed on the electrodes 12. Also, a flow channel layer 20 to define ink chambers 21a is disposed on the substrate 10, and a nozzle layer 30 forming nozzles 31 for ink ejection is disposed on the flow channel layer 20. A glue layer 15 is provided between the flow channel layer 20 and the substrate 10 so that the flow channel layer 20 is bonded onto the substrate 10. A temperature sensing unit (part) 43 may include a plurality of temperature sensing elements formed between the passivation layer 13 and the anti-cavitation layer 14. Although this embodiment of the present general inventive concept illustrates that the temperature sensing elements of the temperature sensing unit 43 are formed between the passivation layer 13 and the anti-cavitation layer 14, it would be appreciated by those skilled in the art that the temperature sensing elements of the temperature sensing unit 43 may be formed at any positions on the heaters 11.

The temperature sensing elements of the temperature sensing units 43 may be installed in a thermal path from the heater 11 to the corresponding ink chamber 21a or may be installed at a position within a nozzle module having the ink chamber 21a, the nozzle 31, and an ink ejecting force generator, for example, the heater 11 to generate one or more bubble to eject the ink from the ink chamber 21a through the nozzle 21, to detect the temperature of the ink ejecting force generator, for example, the heater 11.

It is possible that the temperature of the heater may represent a temperature of the ink disposed to correspond to the heater and/or nozzle since the ink is supposed to be ejected through the nozzle from the ink chamber according to heat of the heater. In a case that the nozzle is defective or a missing nozzle, the nozzle does not function in a normal ink ejecting operation but is clogged. Therefore, the temperature of the ink contained in the ink chamber is different from the temperature of other ink contained in other ink chamber since other ink in the other ink chamber and the corresponding nozzle are functioning in the normal ink ejecting operation.

The substrate 10 is configured as a silicon wafer and is formed with an ink supply hole 10a through which the ink is supplied from an ink storage part (not illustrated). The heaters 11 provided on the substrate 10 are configured as a typical thin film heater, and heat the ink in the chambers 21a by converting an electric signal transmitted from the electrodes 12 into a thermal energy. The heaters 11 may be made of a heat resistant material, such as tantalum nitride (TaN) or tantalum-aluminum (Ta—Al). The electrodes 12 are formed by depositing a metal material having a sufficient conductivity, such as aluminum (Al). The deposited metal layers are formed on the heaters 11 in a predetermined wiring pattern by a photolithography process and an etching process. The electrodes 12 receive a signal from a typical CMOS logic and a power transistor, and transmit the signal to the heaters 11.

A heat storage layer 16 may be provided between the heaters 11 and the substrate 10, as an insulation layer configured as a silicon oxide film. The heat storage layer 16 functions to prevent the heat generated from the heaters 11 from escaping (being transferred) to the substrate 10.

The passivation layer 13 protects the heaters 11 and the electrodes 12 by preventing the heaters 11 and the electrodes 12 from being oxidized or directly contacting the ink. The passivation layer 13 may be configured as a silicon nitride (SiN) film which has a good insulation property and heat transfer efficiency. The anti-cavitation layer 14 may be provided on the passivation layer 13, above heat generating regions of the heaters 11 corresponding to the nozzles 31.

The anti-cavitation layer 14 protects the heaters 11 from a cavitation force which is generated when the bubbles in the chambers 21a contract and collapse, and prevents the heaters 11 from corroding due to the ink. The anti-cavitation layer 14 is formed by depositing tantalum (Ta) on the passivation layer 13 by a predetermined thickness.

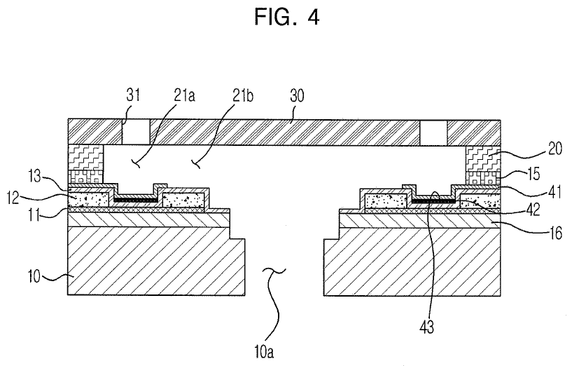

The anti-cavitation layer 14 can be formed by depositing tantalum (Ta) on the temperature sensing parts 43, at the positions corresponding to the nozzles, and patterning the same. However, as shown in FIG. 4, the anti-cavitation layer may be eliminated. Though the anti-cavitation layer is eliminated, the temperature sensing parts 43 provided on the passivation layer 13 detect the temperature of the heaters 11, and additionally protect the heaters 11 from a cavitation force which is generated when the bubbles in the chambers 21a contract and collapse. The temperature sensing parts 43 have a width corresponding to the heat generating regions of the heaters 11. Accordingly, in the modified embodiment, since the process of forming the anti-cavitation layer by the deposition and the patterning of tantalum (Ta) can be omitted, a process efficiency is enhanced.

The flow channel layer 20 defines an ink passage 21 to connect the ink supply hole 10a and the nozzles 31. The ink passage 21 has the chamber 21a in which the ink is filled, and a restrictor 21b which connects the ink supply hole 10a and the chamber 21a to restrict a flow of the ink between the ink supply hole 10a and the ink chamber 21a.

Between the passivation layer 13 and the anti-cavitation layer 14 are provided a first metal layer 41 and a second metal layer 42 as the temperature sensing elements which form the temperature sensing unit 43 to detect the temperature of the heater 11.

The temperature sensing elements of the temperature sensing unit 43 may have a thin film thermocouple. A temperature sensor using a temperature coefficient of resistance (TCR) may be used as a temperature sensor to detect the temperature. However, the temperature sensor using the TCR just detects an average temperature of a relatively broad area because it detects the temperature by using a resistance variation value of a metal, but cannot detect the temperature of a specific point or position. Accordingly, the present general inventive concept provides the temperature sensing part 43 using the thermocouple.

The thermocouple is a temperature sensor in which two different types of metals are arranged in a closed loop, one of two junctions formed between two types of metals contacting each other in the closed loop is connected to a high-temperature side, and the other junction is connected to a low-temperature side. Such a thermocouple uses a seebeck effect such that an electromotive force is generated according to the kinds of metals in the closed loop and the temperature difference between two junctions. Here, the seebeck effect may be a conversion of temperature differences to electricity to represent a temperature.

In the present embodiment, the thermocouple is structured such that one junction between two types of metals contacting each other is directly connected to a region, of which a temperature is to be detected, and the other opened (non-contacted) ends of two respective metals are connected to a data acquisition board, thereby easily obtaining a temperature signal. Based on the temperature signal, the thermocouple can detect conveniently the temperature of the desired region. The thermocouple can be classified into various types according to the kinds of two metals consisting of the thermocouple.

A k-type thermocouple using chromel and alumel can be used in the present embodiment.

By using the k-type thermocouple including chromel and alumel, the first metal layer 41 and the second metal layer 42 as the temperature sensing elements of the temperature sensing part 43 can be formed such that one end of the first metal layer 41 and one end of the second metal layer 42 are bonded onto the passivation layer 13 so as to easily detect the temperature of the heater 11.

The first metal layer 41 may be formed by depositing chromel through sputtering or chemical vapor deposition, and patterning the same. Similarly, the second metal layer 42 may be formed by depositing alumel through sputtering or chemical vapor deposition, and patterning the same.

The heating temperature of the heater 11 is measured by the temperature sensing part 43, an analog signal of the measured temperature is converted into a digital signal through an A/D converter (not shown), and the digital signal is transmitted to a control part 50 (which will be described later).

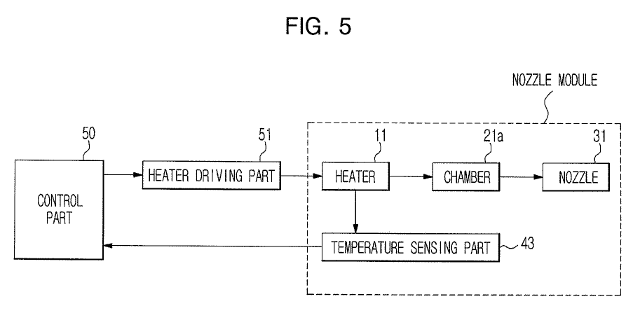

FIG. 5 is a control block diagram illustrating an image forming apparatus having an ink jet print head according to an embodiment of the present general inventive concept. The image forming apparatus according to the present embodiment includes a control part 50 and a heater driving part 51.

Referring to FIGS. 1 through 5, the control part 50 drives the heater 11 through the heater driving part 51 according to an input signal of a printing operation to eject the ink using an ink ejecting force to form an image on a printing medium.

A unit nozzle module, which includes the chamber 21a defined by the flow channel layer 20, the heater 11 provided below the chamber 21a, the temperature sensing part 43 detecting the temperature of the heater 11, and the nozzle 31 provided on the chamber 21a, is formed in plural numbers in the ink jet print head.

In the nozzle module, the bubbles are generated in the ink in the chamber 21a by driving the heater 11, and the ink droplets are ejected through the nozzle 31 by the expansive power (ink ejecting force) of the bubbles.

At this time, the temperature sensing unit 43 detects the temperature of the heater 11 when the heater 11 is driven. The temperature signal detected by the temperature sensing unit 43 is transmitted to the control part 50.

The second metal layer 42 and each end of the first metal layers 41 are connected to terminals of the temperature sensing unit 43 such that the heat received from the heater 11 is transferred to the temperature sensing unit 43, and a voltage signal representing the temperature detected by the temperature sensing unit 43 is output to the control part 50. Accordingly, the terminals of the temperature sensing unit 43 are connected to one distal end of the second metal layer 42 and each distal end of the respective first metal layers 41, and the temperature sensing unit 43 detects the temperature using the heat of each junction formed by the second metal layer 42 and each end of the first metal layers 41, and also detects a location of the heater according to the detected temperature and connections (junctions) of the second metal layer 42 and the respective first metal layers 41.

For example, when one of the nozzles 31 is a missing nozzle (defective nozzle), one of the junctions formed by the first metal layer 41 and the second metal layer 42 illustrates a temperature different from other junctions since the junctions are disposed between the corresponding ink chamber 21a and the corresponding heater 11. A voltage signal representing a temperature of the one junction detected by the temperature sensing unit 43 may be different from other voltage signals representing other temperatures of the other junctions. According to the difference between the voltage and the other voltages, the control part 50 can determine the corresponding nozzle as the missing nozzle and the location of the missing nozzle.

When the ink jet print head includes a plurality of rows of nozzles, a plurality of second metal layers 42 may be disposed along the heaters corresponding to each row of the nozzles, and may be connected to the respective temperature sensing units 43. Here, a single temperature sensing unit can be used to be connected to the plurality of second metal layers 42. The control part 50 may detect a voltage to represent a temperature of each heater using each of the first metal layers 41 and each of plurality of second metal layers 42.

When the heater 11 generates heat by the signal of the control part 50 in the normal state, because the heated ink in the chamber 21a is ejected through the nozzle 31, the heater 11 is kept in a predetermined temperature range. In other words, when the ink is normally ejected through the nozzle 31, the heater 11 is kept in a temperature range of, for example, 298° C.±30° C., at which the bubbles are generated in the ink.

If the heater 11 generates heat while the nozzle 31 is clogged, because the ink in the chamber 21a cannot be ejected through the nozzle 31, the temperature of the heater 11 rises continuously over, for example, 330° C.

Also, if the heater 11 works improperly and does not generate heat, the heater 11 is kept in an ambient temperature.

When the missing nozzle is generated, i.e., the nozzle 31 is clogged or the heater 11 does not generate heat, the temperature of the heater 11 deviates from the predetermined temperature range, for example, 298° C.±30° C. Accordingly, if the control part 50 monitors the temperature of the heater 11 and determines that the temperature of the heater 11 deviates from the above temperature range, the control part 50 determines that the nozzle 31 of the corresponding nozzle module is a missing nozzle.

In order to reduce an error of the determination of the missing nozzle, if the detected temperature of the heater 11 is less than, for example, 100° C., the control part may determine that the heater does not generate heat. And, if the detected temperature of the heater 11 is more than, for example, 330° C., the control part determines that the nozzle 31 is clogged. In other words, if the predetermined temperature range is broadened, e.g., from 100° C. to 330° C., and the temperature of the heater 11 deviates from the predetermined temperature range, it is determined that the nozzle 31 of the corresponding nozzle module is a missing nozzle.

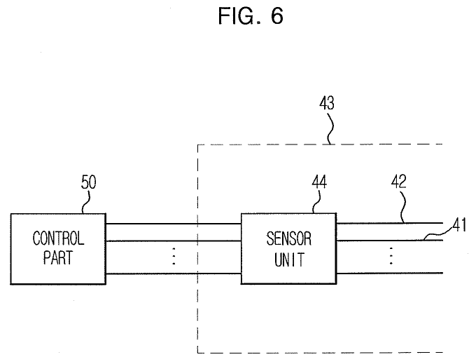

FIG. 6 is a block diagram illustrating a control part and a temperature sensing unit of the image forming apparatus of FIG. 5 according to an embodiment of the present general inventive concept. Referring to FIGS. 1, 5, and 6, the temperature sensing unit 43 includes a sensor unit 44 to detect voltages representing temperatures of the junctions of the second metal layer 42 and the respective first metal layers 41. The sensor unit 44 may include a plurality of sensors to correspond to the second metal layer 42 and each of the respective first metal layers 41 and to generate signals representing the respective temperatures of the junctions of the second metal layer 42 and the respective first metal layers 41 according to the respective heats. The control part 50 may be connected to the sensing unit 44 to receive the generated signals.

After detecting the missing nozzle, the deterioration of a printing quality is prevented through various missing nozzle compensating methods. One example of the missing nozzle compensating methods is disclosed in Korean Patent Laid-Open Publication No. 2006-0067056. Since various conventional missing nozzle compensating methods can be adapted to the present general inventive concept, the explanation thereof is omitted.

For example, another nozzle can be used to eject ink on a portion of the printing medium where the missing nozzle is supposed to eject ink to form an image, so that the portion of the printing medium where the ink is not ejected from the missing nozzle is compensated by using the another nozzle. It is possible that a conventional maintenance operation can be used as the missing nozzle compensating method.

Because the missing nozzle is detected through the above detecting process whenever performing the printing operation, the missing nozzle can be found out promptly, when compared to a conventional missing nozzle detecting method using a scanning operation, and the missing nozzle can be accurately detected without a scanning sensor of high resolution.

Also, a series of complicated processes of the printing and the scanning can be omitted, and unnecessary printing operations are not carried on, thereby preventing a waste of a printing medium or an ink.

As apparent from the above description, the apparatus and method of detecting a missing nozzle and the ink jet print head using the same according to the present general inventive concept can promptly detect the missing nozzle, compared to a conventional missing nozzle detecting method using a scanning operation, because it is determined whether the missing nozzle is generated by using the heating temperature of the heater whenever performing the printing operation.

Moreover, the missing nozzle can be accurately detected without a scanning sensor of high resolution.

Furthermore, the missing nozzle can be detected by a simple process, and unnecessary printing operations are not carried on, thereby preventing a waste of a printing medium or an ink.

Although a few embodiments of the present general inventive concept have been shown and described, it would be appreciated by those skilled in the art that changes may be made in these embodiments without departing from the principles and spirit of the general inventive concept, the scope of which is defined in the appended claims and their equivalents.

What is claimed is:

1. A method of detecting a missing nozzle used in an ink jet print head of an image forming apparatus provided with plural chambers in which an ink is filled, plural heaters to heat the ink in the chambers, and plural nozzles corresponding to the heaters, comprising:
detecting a temperature of each of the heaters; and
when the detected temperature deviates from a predetermined temperature range, determining that a nozzle corresponding to the heater is a missing nozzle.

2. The method of claim 1, wherein the detecting of the temperature comprises detecting the temperature using a thin film thermocouple which is deposited on an upper portion of each of the heaters.

3. The method of claim 2, wherein the thermocouple comprises a k-type thermocouple.

4. The method of claim 1, wherein the predetermined temperature range is between 100° C. and 330° C. inclusive.

5. An image forming apparatus comprising:
plural nozzle modules which include chambers in which an ink is filled, nozzles corresponding to the chambers, and heaters to heat the ink in the chambers;
one or more temperature sensing units which are provided in the respective nozzle modules to detect a heating temperature of the heaters; and
a control part which determines whether a missing nozzle is generated,
wherein when the temperature detected by the one or more temperature sensing units deviates from a predetermined temperature range, the control part determines that the nozzle of the corresponding nozzle module is a missing nozzle.

6. The image forming apparatus of claim 5, further comprising:
a passivation layer to protect the heaters,
wherein the one or more temperature sensing units are provided on the passivation layer, correspondingly to the heaters.

7. The image forming apparatus of claim 6, further comprising:
an anti-cavitation layer provided on the passivation layer,
wherein the one or more temperature sensing units are provided between the passivation layer and the anti-cavitation layer, correspondingly to the heaters.

8. The image forming apparatus of claim 5, wherein the one or more temperature sensing units comprise a thin film thermocouple.

9. The image forming apparatus of claim 6, wherein the one or more temperature sensing units perform a cavitation-prevention function.

10. An image forming apparatus comprising:
a substrate which is formed with heaters and a passivation layer protecting the heaters;
a flow channel layer which defines chambers corresponding to the heaters and a flow channel connected to the chambers;
a nozzle layer which is formed with nozzles corresponding to the chambers;
first and second metal layers which are bonded onto the passivation layer, correspondingly to the nozzles, to form one or more temperature sensing units; and
a control part which determines whether a missing nozzle is generated,
wherein when a temperature detected by the one or more temperature sensing unit deviates from a predetermined temperature range, the control part determines that the nozzle is a missing nozzle.

11. An ink jet print head comprising:
a plurality of nozzle modules each having a chamber in which an ink is filled, a nozzle corresponding to the chamber, and a heater to heat the ink in the chamber; and
a temperature sensing unit provided in the respective nozzle modules to detect a heating temperature of the heater of the respective modules.

12. An image forming apparatus comprising:
an ink jet print head comprising:
a plurality of nozzle modules each having a chamber in which an ink is filled, a nozzle corresponding to the chamber, and a heater to heat the ink in the chamber; and
a temperature sensing unit provided in the respective nozzle modules to detect a heating temperature of the heater of the respective modules.

13. The image forming apparatus of claim 12, further comprising:
a control part connected to the ink jet print head to determines whether the nozzle is a missing nozzle when the heating temperature detected by the temperature sensing unit deviates from a predetermined temperature range.

14. The image forming apparatus of claim 12, wherein:
the temperature sensing unit comprises first temperature sensing elements disposed to correspond to positions of heaters of the nozzle modules, and a second temperature sensing element disposed along the heaters to be connected to the positions of the first temperature sensing elements; and
the heating temperature comprises a plurality of temperatures to correspond to the positions formed between the respective first temperature sensing elements and the second temperature sensing element.

15. The image forming apparatus of claim 12, wherein the temperature sensing unit comprises a sensor unit connected to the respective first temperature sensing elements and the second temperature sensing element to detect temperatures of the positions corresponding to respective heaters.

16. The image forming apparatus of claim 12, wherein the temperature sensing unit comprises:
a first temperature sensing element and a second temperature sensing element formed to corresponding to the heater of the respective nozzle modules to transfer heat; and
a sensor unit connected to the first temperature sensing element and the second temperature sensing element to detect a temperature of the corresponding heater according as the heating temperature according to the heat.

17. The image forming apparatus of claim 12, wherein:
the respective heaters generate heat to be transmitted to the temperature sensing unit; and
the temperature sensing unit detects the heating temperature of the heater among the heaters according to a difference of the heat among the respective heaters.

18. The image forming apparatus of claim 12, wherein the temperature sensing unit is disposed on a path formed from the heater to the ink chamber.

19. The image forming apparatus of claim 12, wherein
the nozzle modules comprise:
a substrate which is formed with heaters and a passivation layer protecting the heaters,
a flow channel layer which defines chambers corresponding to the heaters and a flow channel connected to the chambers,
a nozzle layer which is formed with nozzles corresponding to the chambers; and
the temperature sensing unit comprises:
first and second metal layers which are bonded onto the passivation layer to correspond to the respective nozzles, to form the temperature sensing unit.

20. The image forming apparatus of claim 19, further comprising:
a control part which determines whether one of the nozzles is a missing nozzle when the temperature detected by the temperature sensing unit deviates from a predetermined temperature range.

21. The image forming apparatus of claim 12, further comprising:
a control part which determines whether one of the nozzles is a missing nozzle when the temperature detected by the temperature sensing unit deviates from a predetermined temperature range,
wherein the ink jet print head and the control part are formed in a single integrated body.

22. The image forming apparatus of claim 12, wherein the plurality of nozzle modules and the temperature sensing unit are formed in a single monolithic body.
